(19) United States
(12) Patent Application Publication
(10) Pub. No.: US 2008/0267107 A1
(43) Pub. Date: Oct. 30, 2008

(54) ATTRACTION WAIT-TIME INQUIRY APPARATUS, SYSTEM AND METHOD

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/933,118

(22) Filed: Oct. 31, 2007

Related U.S. Application Data
(60) Provisional application No. 60/926,493, filed on Apr. 27, 2007.
(60) Provisional application No. 60/937,529, filed on Jun. 27, 2007.

(51) Int. Cl. H04H 20/71

(52) U.S. Cl. 370/312

(57) ABSTRACT

Methods and apparatus are disclosed that enables a plurality of users of portable computing devices to each individually request and receive wait-time indications for each of a plurality of attractions within a physical establishment. In certain embodiments the attractions are rides and the physical establishments are amusement parks. In this way, users of portable computing device, such as mobile phones, may individually request and receive wait-time indications for each of a plurality of rides within at least one of a plurality of amusement parks. The methods and apparatus may be configured to maintain and access a database of wait-time values for a plurality of attractions within one or more physical establishments. In certain embodiments, request messages are received as SMS text messages from mobile phone and response messages are sent as SMS text messages to mobile phones.

This application claims the benefit of U.S. Provisional Application 60/926,493 filed Apr. 27, 2007 and 60/937,529 filed Jun. 27, 2007 which are incorporated herein in their entirety by reference.

This application hereby incorporates in its entirety, US Patent Publication No. 2006/095361 for a Location-Based Demographic Profiling System and Method of Use.

### BACKGROUND OF THE INVENTION

1. Field of the Invention

The present invention relates generally to information technology, and more specifically to the distribution of wait-time information for attractions.

2. Discussion of the Related Art

Mobile communication devices such as cell phones and personal digital assistants provide individuals with access to information in a variety of environments. Mobile communication devices are becoming increasingly ubiquitous with many individuals carrying these devices for both work and play.

The global positioning system (GPS) allows a person with a GPS receiver to determine their present position through satellite ranging. Many mobile communication devices are GPS enabled allowing persons using the device to determine their present position.

Many establishments (e.g. amusement parks) have many attractions (e.g. rides) with long lines. The long lines and their associated wait-times, however, do not necessarily correlate well with customer demand. This is because customers do not have easy access to wait-time information for the attractions. For example, the current wait-time for a very popular ride may be forty-five minutes while another equally popular ride may have only a fifteen minute wait-time. A customer waiting in the forty-five minute line may prefer to switch rides to shorten their wait-time. The customer would make the switch if only the customer knew of the shorter wait-time.

Those skilled in the art will recognize that there is a need to provide customers of establishments with current attraction wait-time information.

### SUMMARY OF THE INVENTION

Several embodiments of the invention advantageously address the need above as well as other needs by providing an attraction wait time inquiry apparatus system and method.

In one embodiment, the invention can be characterized as a method for distributing attraction wait-times, the method comprising: maintaining a database of wait-times for attractions; receiving a request message requesting wait-times for an attraction; retrieving the wait-times for the attraction from the database; and sending a response message with the retrieved wait-times.

In another embodiment, the invention can be characterized as a method for distributing attraction wait-times, the method comprising: maintaining a database of wait-times for attractions at establishments; sending from a mobile phone a request message having a request for wait-times for an attraction at an establishment; receiving the request message; retrieving the wait-times associated with the attraction and the establishment from the database; and sending a response message with the retrieved wait-times to the mobile phone.

In a further embodiment, the invention may be characterized as an apparatus for distributing attraction wait-times comprising: a database for storing wait-times for attractions and adapted to, receive a request message requesting wait times for an attraction, retrieve the wait-times for the attraction, and send a response message having the wait-times for the attraction; and a mobile communication device operative to send the request message to the database and receive the response message from the database.

In yet another embodiment, the invention may be characterized as an apparatus for distributing attraction wait-times comprising: a database for storing wait-times for attractions and adapted to, receive a request message requesting wait times for an attraction, retrieve the wait-times for the attraction, and send a response message having the wait-times for the attraction; and a mobile communication device operative to, determine a present position of the mobile communication device; send the request message including the present position to the database, receive the response message from the database.

In a still further embodiment, the invention may be characterized as a method for distributing attraction wait-times, the method comprising: maintaining a database of wait-times for attractions at establishments; determining the present position of a mobile communication device; sending from the mobile communication device a request message having the present position and requesting wait-times for an attraction at an establishment; receiving the request message; retrieving the wait-times associated with the attraction and the establishment from the database; and sending a response message with indicia of the attraction the retrieved wait-time to the mobile phone.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 shows a block diagram of an attraction wait-time inquiry system according to an embodiment of the present invention

FIG. 2 shows a first exemplary mobile communication device according to an embodiment of the present invention.

FIG. 3 shows a second exemplary mobile communication device according to an embodiment of the present invention.

FIG. 4 shows a third exemplary mobile communication device according to an embodiment of the present invention.

FIG. 5: shows a fourth exemplary mobile communication device according to an embodiment of the present invention.

FIG. 6: shows a fifth exemplary mobile communication device according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Various embodiments of the present invention enable users of a mobile communication device, such as a cell phone, personal digital assistant, portable computing device or the like, to receive information regarding the anticipated wait-times at one or more attractions at an establishment. In one exemplary embodiment, a computer moderated service includes a computer server that maintains or has access to data related to wait-times for attractions within one or more establishment such as the wait-times for rides at various amusement parks.

In some embodiments, establishments are assigned a unique establishment ID. The establishment ID might be for example an alpha string, a numeric string, an alphanumeric string or the like. In addition, each establishment may be given a unique establishment abbreviation that may be associated with the establishment ID. The establishment abbreviation may be for example an easy to remember or easy to type text string. An abbreviation such as DL may be given to Disneyland since the abbreviation DL for Disneyland is both easy to remember and easy to type.

An exemplary listing of seven major establishments in the United States along with example establishment abbreviations and establishment IDs is shown below.

| Establishment | Abbreviation | ID |
|---|---|---|
| Disneyland | DL | 10001 |
| California Adventure | CE | 10002 |
| Disneyworld | DW | 10003 |
| Epcot Center | EC | 10004 |
| Universal Studios Florida | UCF | 10005 |
| Universal Studios Hollywood | UCH | 10006 |
| Busch Gardens Tampa Bay | BGTB | 10007 |

Each attraction at an establishment may be assigned a unique attraction ID. For example, each ride, show, event, or other attraction at Disneyland may be assigned a different attraction ID. The attraction ID may be an alpha string, a numeric string, an alphanumeric string or the like. Each attraction may also be given an attraction abbreviation that is an easy to understand representation of the name of the attraction. The use of an attraction abbreviation facilitates display of indicia representing the attraction on mobile communication devices such as cell phones that display Short Message Service (SMS) messages. SMS messages have limited character lengths and thus the use of attraction abbreviations allows for more information to be conveyed in a single SMS message.

An exemplary listing of major attractions at Disneyland along with an exemplary attraction ID and attraction abbreviation is shown below.

| Attraction | Text Abbreviation | Attraction ID |
|---|---|---|
| Jungle Cruise | Jungle | 01 |
| Splash Mountain | SplshMtn | 02 |
| Haunted Mansion | Haunted | 03 |
| Big Thunder Mountain Railroad | BigThdr | 04 |
| Space Mountain | SpceMtn | 05 |
| Matterhorn Bobsleds | Mattrhrn | 06 |
| Indiana Jones Adventure | IndianaJns | 07 |
| Star Tours | StarTrs | 08 |
| Finding Nemo Submarine Voyage | Nemo | 09 |
| Mr. Toad's Wild Ride | Toad | 10 |
| Pirates of the Caribbean | Pirates | 11 |
| Mad Tea Party | Tea | 12 |
| Autopia by Chevron | Autopia | 13 |

In this embodiment, a central server is configured to maintain data or access data for one or more establishments through an establishment ID and one or more attractions through an attraction ID. For each attraction ID, the data includes a wait-time for the attraction. The data may be conveniently stored and indexed through a data structure such as:

Attraction_Wait_Time [Establishment ID, Attraction ID]=estimated wait-time

Using this exemplary data structure, a wait-time for the Splash Mountain ride at Disneyland 45 minutes may be stored as:
Attraction_Wait_Time [10001, 02]=45 minutes

In this embodiment, the data structure is stored in a wait-tracking database that includes wait-times or related values for each attraction at each establishment.

At popular attractions, customers form and wait on lines before they are admitted to the attractions. For example, customers at the Disneyland establishment might wait on a line before being admitted to the Splash Mountain attraction. The time a customer waits in line is generally a function of (a) the number of customers who are in line (b) the rate the line is moving. By counting or estimating the number of customers in line and measuring or estimating the rate the line is moving an estimated wait-time may be determined. The estimated wait-time may also be calculated or adjusted to compensate for other effects to wait-time such as the effect of customers having special passes or privileges that allow them to bypass at least a portion of the line.

The estimated wait-time for an attraction is the amount of time a customer can expect to wait before they are admitted to the attraction. In the example above, if the estimated wait-time for the Splash Mountain attraction at the Disneyland establishment is currently 45 minutes, a customer who joins the line at Splash Mountain at the time of the estimate can expect to wait on line for 45 minutes before being admitted to the attraction and stepping on board one of the boats featured in the ride.

In another exemplary embodiment, a computer moderated service enables users of mobile phones to selectively access current wait-times for attractions at establishments by sending a coded electronic message to a central server. The electronic message may be, for example, an SMS message sent from a mobile phone to the central server using a designated short code or phone number address. The SMS message may include, for example, an establishment ID for which a mobile phone user desires wait-time information. The SMS message may also include attraction IDs for one or more attractions for which the mobile phone user desires to receive the current estimated wait-times. The central server responds to the SMS message by sending a response SMS message to the mobile phone. The response SMS message may include the estimated wait-time, the number of customers currently in line or any other indicia of wait time.

For example, the user may send an electronic message to the central server by sending an SMS message to short code “92487” which corresponds to the letters WAITS on a telephone keypad. The SMS message sent by the user may include an establishment ID or an establishment abbreviation. The SMS message may also include one or more attraction IDs or attraction abbreviations. More specifically, the user might send the following text message to the short code address 92487:
“DL 02 05 07 08”

This wait-time request message represents a request for current wait-times for attractions at the Disneyland establishment as indicated by the establishment abbreviation, DL. In addition, this wait-time request message includes a specific request for current wait-times at Splash Mountain, Space Mountain, Indiana Jones Adventure, and Star Tours attractions as indicated by the 02, 05, 07 and 08 attraction IDs in the message. The wait-time request message provides a simple and short coded message that may be sent by through a mobile phone or other device with SMS message capability.

In some embodiments, the specific attractions need not be identified by Attraction ID in each wait-time request message. Instead, a standard set of attractions may be used or a pre-configured set of attractions may be used (explained further hereinafter).

In response to a wait-time request message, the central server accesses the current wait-times for one or more attractions of the identified establishment and returns the wait-times in a response message. The message may be, for example, an SMS message that includes a list of the particular wait times for particular attractions. To save space, the attraction abbreviation for a particular attraction may be used. An example of the wait-time response message might be:
“SplshMtn:30 SpceMtn:45 IndianaJns:50 StarTrs:50”

The SMS message indicates to the mobile phone or other mobile device user that the current wait-time for the Splash Mountain attraction is 30 minutes, the current wait-time for the Space Mountain ride is 45 minutes, the current wait-time for the Indiana Jones Adventure ride is 50 minutes, and the current wait time for the Star Tours ride is 50 minutes. The attraction abbreviations (i.e. Splsh Mtn, SpcMtn, IndianaJns, StarTrs) are used to conserve characters since SMS messages are generally limited in length. That said, the message may be structured to use the full names of the attractions if space allows.

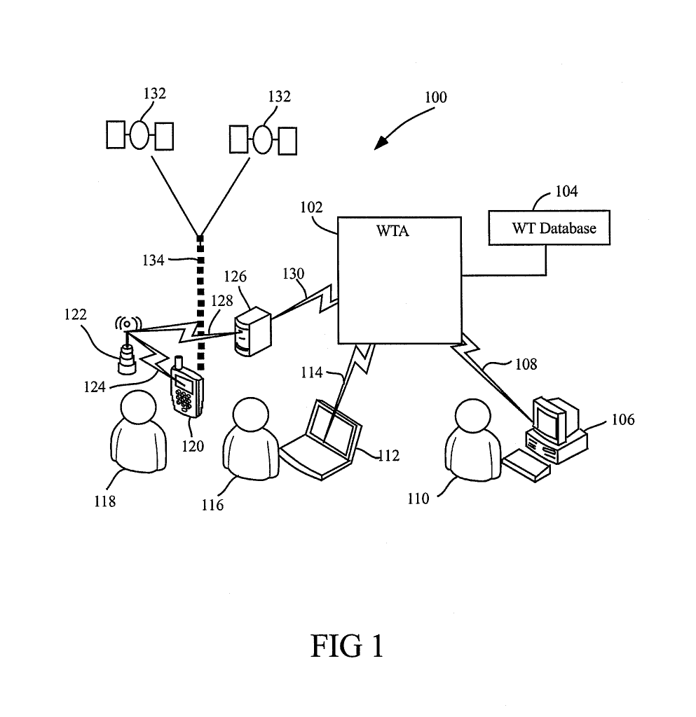

Referring first to FIG. 1, FIG. 1 shows an attraction wait time inquiry system 100 according to an embodiment of the present invention. The wait time inquiry system includes a wait time application (WTA) 102 connected with a Wait-Time (WT) database 104. The WTA 102 receives electronic messages 108 from one or more computers 106. The computers 106 are operated by one or more operators 110.

The WTA 102 is in communication with one or more client machines 112 through a network 114. The one or more client machines are operated by one or more potential customers 116. The WTA is also in communication with one or mobile phones 120 through an SMS gateway 126 and mobile service provider 122 through communication links 124, 128, 130. The mobile phone receives signals 134 from GPS 132 satellites.

The WTA 102 is hosted on a server or a group of servers and maintains the WT database 104 having wait-times associated with attractions at establishments. The wait-times may be indexed by attraction ID, establishment ID or any other suitable attraction and/or establishment indicia. The WT database 104 may store a variety of data related to attraction wait-times including, for example, the (a) current wait-times (b) the length of the line (c) historical wait-times (d) historical line lengths (e) historical customer throughput rates or (f) other data related to estimating wait-times at attractions. In some embodiments, the WT database 104 also stores historical wait-time data including wait-time related averages, statistics and/or trend data.

In this exemplary embodiment, the WT Database 104 is configured to store two or more wait-time values for each attraction at each establishment including (1) a current wait-time for each attraction and (2) an average or otherwise typical wait-time for each attraction.

In other embodiments, the WT Database 104 is configured to store multiple historical wait-times for each attraction, the multiple historical values including stratified averages or typical wait-times for the attractions. For example, a first average wait-time may be stored for weekdays and a second average wait-time may be stored for weekends; a first average wait-time may be stored for mornings and a second average wait-time value may be stored for midday and a third average wait-time for evenings; and/or a separate average wait-time value may be stored for each season of the year. Thus, the WT database 104 maintains historical data about a variety of wait-time parameters, including the average wait-time for attractions at different times of the day, on different days of the week, in different seasons of the year and/or any other wait-time data category.

It should be noted that in some embodiments, wait-times for particular attractions are stored in the WT database 104 as estimated wait-times for a customer that joins the line at that attraction at the current time. In other embodiments, the WT database 104 stores line lengths along with customer throughput rates. In these embodiments, the WTA 102 calculates an estimated wait-time from the line length and the customer throughput rate.

In some embodiments, the wait-time data stored in the WTA database 104 is updated by the WTA 102. The WTA 102 receives electronic messages 108 from one or more computers 106. The computers 106 may be, for example, a personal computer, a portable computer, a mobile phone, a personal digital assistant or any other type of data entry device. The computers 106 may have operators 110 that are attraction or establishment staff.

The electronic messages 108 contain data updates related to the wait-times at attractions. A single electronic message 108 might contain the current wait-time or the customer throughput rate at a particular attraction. Electronic messages 108 may be sent by an operator 110 such as a ride attendant or may be sent automatically by the computer 106. For example, the computer 106 may be in communication with one or more sensors (not shown) such as a turnstile sensor. The information can be automatically forwarded to the WTA 102 in periodic electronic messages 108. It should be noted that information such as turnstile information can be used to estimate wait-times by providing information such as the customer throughput rate at an attraction.

In response to receiving an electronic message 108 from the computer 106, the WTA 102 processes the message and updates the WT Database 104. For example, if an electronic message 108 indicates that Splash Mountain has a current wait-time value of 45 minutes, the WTA 102 will update the WT database 104 accordingly.

In this embodiment, the electronic message 108 includes the attraction ID and establishment ID. In alternate embodiments, the electronic message 108 includes the attraction abbreviation and the establishment abbreviation. Still other embodiments feature electronic messages 108 that include an attraction ID or other indicia of an attraction. The electronic message 108 of this embodiment also includes the current wait-time, line length, and/or customer throughput rate. Other embodiments feature electronic messages 108 having other indicia of the wait-time at an attraction.

In other embodiments, the electronic messages 108 are SMS messages from mobile phones. Mobile phones provide a convenient and portable way to send wait-time information to the WTA 102. The SMS messages may include for example an establishment ID, an attraction ID, and a current wait-time. In other embodiments the SMS messages may include an establishment abbreviation or attraction abbreviation.

For example, a ride attendant or an automated computer 106 at Splash Mountain in Disneyland could send an electronic message 108 to the short code address of the WTA 102. The message might for example comprise the following text string:
DL 02 55”

The electronic message 108 represents an update of the wait-time for the Splash Mountain attraction at Disneyland. The message characters “DL” represent the Disneyland establishment abbreviation, the numbers “02” represent the Splash Mountain attraction ID and the numbers “55” indicate that the estimated current wait-time at Splash Mountain is now 55 minutes. Those skilled in the art will recognize that this message may be sent quickly and conveniently using a mobile communication device such as a mobile phone.

In other embodiments, electronic messages 108 are sent using other formats or protocols. In some embodiments, the computer 106 communicates with the WTA 102 through the internet or other networks. In some embodiments, a password may also be required to send electronic messages 108 to the WTA.

The WTA 102 receives electronic messages 108 from the computers 106 and the WTA 102 parses the messages and updates the WT Database 104. The WTA 102 also provides customers with reports of current wait times at attractions. The reports can be requested and received through a portable communication device such as a mobile phone or personal digital assistant.

Referring again to FIG. 1, a customer 118 at an establishment (e.g. Disneyland) has a mobile phone 120. The customer 118 is likely to visit a number of different attractions (e.g. Splash Mountain, Space Mountain, Matterhorn Bobsleds etc) throughout the day. When the customer 118 is finished visiting an attraction, the customer 118 may want to know the current wait-times at other attractions in the establishment so that the customer 118 can make an informed decision as to which attraction the customer 118 should visit next.

To obtain an estimate of the current wait-times, the customer 118 sends a request message to the WTA 102 using the mobile phone 120. As described above, the request message may include the establishment ID or establishment abbreviation and the attraction ID or attraction abbreviation. The customer might for example send the following request message to SHORT CODE address 92487 (i.e. the exemplary short code address of the WTA 102):
DW 02 05

The request message represents a request for wait-times at the Disneyworld establishment as indicated by the establishment abbreviation “DW” in the message. In addition, this request message specifically requests the wait-times for the Splash Mountain attraction and Space Mountain attraction as indicated by attraction IDs 02 and 05 in the message. Notably, this simple and short SMS message can be easily created and sent by the customer 118 from their mobile phone 120.

In response to the request message, the WTA 102 accesses the WT Database 104 to access data related to the current wait-times. The WTA 102 generates a response message having the requested wait-times and sends the response message to the mobile phone 120. An example of a response message is shown below:
Disneyworld—SplshMtn:35 SpceMtn:55

The message includes the name of the establishment (i.e. Disneyworld), the abbreviations of attractions (i.e. SplshMtn and SpceMTn) and the estimated wait-times at each attraction. The message may be conveniently displayed on the customer's mobile phone 120. The customer 108 viewing the message on their mobile phone 120 can easily see that the wait-time at the Splash Mountain attraction is 35 minutes and the wait-time at the Space Mountain attraction is 55 minutes.

In some embodiments, a request message may be sent without an attraction ID, attraction abbreviation or other indicia of an attraction. In that case, the WTA 102 may be configured to automatically populate a response message with a predetermined set of attractions. For example, the WTA 102 may automatically populate the response message with the twelve most popular attractions of the establishment. The customer 118 may then simply send a simple request message to short code 92487 (i.e. the exemplary short code for the WTA 102) with the message having just the Disneyland establishment abbreviation “DW”. The WTA 102 receives the request message, decodes the request as a wait time request for the Disneyworld establishment. The WTA 102 then sends a response message with the wait-times for the twelve most popular attractions at the Disneyworld establishment.

As shown in FIG. 1, the mobile phone 120 may be equipped with a Global Positioning System (GPS) receiver (i.e. GPS enabled). If so, the request messages sent to the WTA 102 may include the present position of the mobile phone 120. The present position may be used by the WTA 102 to select appropriate attractions to include in a response message. For example, the WTA 102 may take the present position and select a set of attractions that are closest to the customer 118 or select a set of attractions that is less than a predetermined distance from the customer 118. More specifically, the WTA 102 might be configured to automatically send a response message with the wait-time for the ten attractions that are closest to the customer 118.

In many embodiments, the WTA 102 stores the geodetic position of attractions in the WT database 104. The WTA 102 may compare the geodetic position of the attraction in the WT database 104 with the present position in request messages to determine the appropriate establishment. The WTA 102 may also use present position information to select attractions of greatest potential interest to the customer 118.

According to this embodiment, the WTA is hosted on a server that is a network-based server having commodity hardware (e.g. a Pentium-class computer), operating system (e.g., Linux, Windows, and OS-X), application runtime environment (e.g., Java and ASP) and applications or processes (e.g., Java applets or servlets, linkable libraries, native code, or the like, depending on platform). The server connects to the Internet, or public or private network, or any combination thereof.

Referring back to FIG. 1, many embodiments of the invention are implemented as a managed service (e.g. an ASP model) using a WTA 102 server connected to one or more networks. In this embodiment, the WTA 102 is hosted on a single server. However, a person skilled in the art will appreciate that the WTA 102 may also be hosted on multiple servers. Those skilled in the art will also recognize that the managed service may also be provided by an operator using a set of one or more computing-related entities (systems, machines, processes, programs, libraries, functions, or the like) to provide the functionality describe herein.

As illustrated FIG. 1, the WTA 102 is also in communication with a mobile service provider (MSP) 122 through a gateway, such as SMS gateway 126. Messages sent from the mobile phone 120 to the WTA 102 may be conveyed in a variety of message formats using a variety of protocols, such as SMS messages, email messages, instant messages, and/or direct internet browsing interactions.

Potential customers 116 may register for the managed service by using a client machine 112, mobile phone 120 or any other communication device. In some embodiments, the potential customer 116 may define a set of attractions of interest allowing the potential customer 116 to pre-configure a preferred set of attractions. This allows the WTA 102 to provide more targeted response messages to customer 118 request messages.

Also shown in FIG. 1, is a Global Positioning System (GPS) 132. GPS 132 provides a user of a GPS receiver or GPS enabled device such as mobile phone 120 with geodetic position information like the user's present position in latitude and longitude. The expected accuracy of a GPS 132 estimated position is generally within 100 feet of the user's true position. GPS 132 when combined with accurately surveyed references and error correcting techniques such as differential GPS can often be used to estimate the user's present position within three feet of the user's true position.

In this embodiment, the mobile phone 132 uses civilian signals from GPS 120 to estimate the present position of the mobile phone 132. However, the use of other positioning systems such as GLONASS and Galileo is also contemplated.

GPS 132 is comprised of satellites having clocks precisely synchronized with respect to each other. Ground stations communicate with the satellites to ensure that the clocks remain synchronized. The ground stations also track the satellites and transmit information to the satellites allowing the satellites to calculate their precise position at any given time. The satellites continuously broadcast “time stamped” signals that contain information about the satellite's position. A GPS receiver or a GPS enabled device such as mobile phone 120 also includes a clock. The GPS receiver compares its time with the times broadcast from the satellites to determine how far the receiver is from each satellite (i.e. ranging). Using the broadcast position of the satellites, the receiver or GPS enabled device then can estimate its present position.

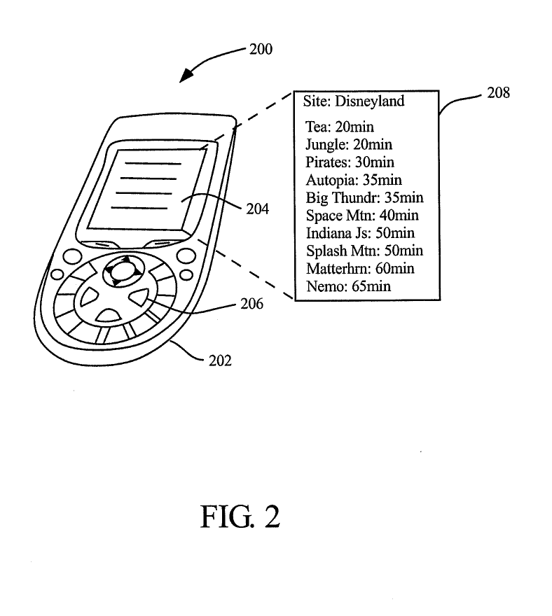

Referring to FIG. 2, FIG. 2 shows a mobile communication device 200 according to an embodiment of the present invention. The mobile communication device 200 includes a user interface 202 having a display 204 and a keypad 206.

In some embodiments, a graphical user interface on the display 206 allows a user to enter information and/or make configuration selections, and/or direct the WTA. For example, the user interface may include menus and/or forms that allow the customer to choose one or more attractions.

The mobile device 202 may be configured as a handheld device such as a mobile phone that includes display functionality and user interface controls. The mobile phone may also communicate with the WTA (not shown) using standard communication protocols, such as the SMS protocols. The mobile phone may also run WTA client software to facilitate communication with the WTA. The mobile phone may also include a differential GPS receiver for determining the user's present position.

For example, a user might send a request message to the WTA, the request message including the establishment abbreviation “DL” for Disneyland. On receiving the request message, the WTA may then send a response message with the wait-times for the ten most popular attractions within the Disneyland establishment. The response message may be displayed on the mobile communication device 200 through standard text messaging display routines, custom client software display routines or any other display techniques. The use of audio responses to supplement or replace the display of the response message is also contemplated.

An exemplary response message 208 is shown in display 204. The response message 208 includes the establishment name “Disneyland”. Also shown in display 204 is a listing of the current wait-times for ten attractions at Disneyland. In this particular embodiment, the WTA ordered the attractions in the response message such that the attractions are listed from the shortest wait-time to the longest wait-time.

In other embodiments, the ordered listing is presented in alphabetical order based upon the name of attraction. In still other embodiments the listing contains a list of attraction ordered by proximity to the user with attractions located closest to the user ordered at the top of the list and the attractions located furthest from the user are ordered at the bottom of the list.

In some embodiments, the WTA assesses if the wait-time associated with an attraction is above or below an average or typical wait-time for that attraction. In some embodiments, the average or typical wait time is selected from an average or typical wait-times based on the current time of day, day of week, and/or season of year. For example, on a Thursday morning, a typical wait-time for an attraction may be compared with the typical wait time for that attraction on weekday mornings.

In the response message the WTA may also include indicia of atypical wait-times at attractions. For example, if the response message is an SMS message, an asterisk may be included next to attractions that have wait-times below an average or typical wait-time for that attraction. The use of asterisks, in some embodiments, is reserved for attractions having wait-times that are less than an average or typical wait time by a threshold amount or percent.

In an exemplary embodiment, the WTA is configured to include an asterisk next to the name of any attraction for which the current wait-time is more than 20% below the average or typical wait time for that attraction at the particular time of day and/or day of week and/or season of year. The asterisk is embedded in the response message is then displayed to the user. The asterisk indicates to the mobile device 202 user that now is a good time to visit the attraction because the wait-times for the attraction are substantially shorter than normal. Those skilled in the art will appreciate that there are many different ways to parse and order attraction wait-times.

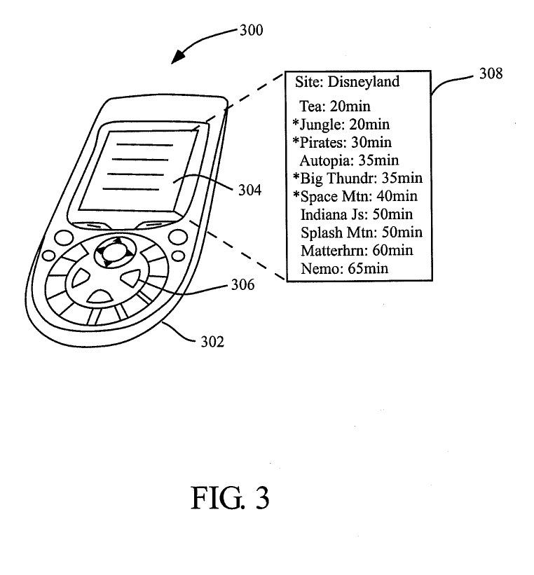

Referring next to FIG. 3, FIG. 3 shows a mobile communication device 300 according to an embodiment of the present invention. The mobile device communication device 300 includes a user interface 302 having a display 304 and a keypad 306.

The display 304 shows an exemplary response message 308 sent to the mobile communication device 300 by the WTA (not shown). As shown, the response message 308 includes an ordered listing of wait-times for attractions ordered from the shortest to the longest wait-times. In addition, an asterisk is displayed next to each attraction in the listing for which the current wait-time is less than 20% below the average or typical wait time for that attraction. In this example, the asterisks are shown next to Jungle Cruise, Pirates of the Caribbean, Big Thunder Railroad, and Space Mountain attractions indicating a 20% below average wait-time for these attractions.

In some embodiments, the system may be configured to convey and display to a customer not only the current wait-time for a particular attraction but also an average or typical wait-time for that attraction. In this way, a customer may be able to directly assess how favorable the current wait-time is compared to historical wait-times. In these embodiments, the WTA accesses data from the WT database such as current wait-times for attractions and average or otherwise typical wait-times for the attractions. In some embodiments, the average or typical wait-time for an attraction is determined with respect to the current time of day, day of week, season of year and/or any other statistical strata.

The WTA includes this information in the response message as an indication of both the current wait-time for an attraction and the average or typical wait time for the attractions. The mobile communication device 300 may then display the current wait time along with the average or typical wait time for attraction. This information may be displayed, for example, in a format such as “current wait time/typical wait time” that allows a customer to easily compare the current wait time with a typical wait time for each attraction.

In addition, the WTA may compute a ratio of current wait-times to typical wait-times. A ratio of approximately 1 indicates that the current wait-time for an attraction is at or near the typical wait time for that attraction. A ratio of less than 1 indicates that the current wait time is less than what is typical for that attraction. A ratio of more than 1 indicates that the current wait time is more than what is typical for that attraction. More specifically, a ratio of 0.7 indicates that the current wait-time is 70% of the typical wait-time for that attraction. This would be favorable indication for the attraction. A ratio of 2.5 indicates that the current wait time is more than double what is typical for that attraction. This would be unfavorable indication for the attraction.

In some embodiments, the ratio is sent to the user as part of the response message and displayed to the user in numerical and/or graphical form. In other embodiments, a listing of attractions is generated and displayed such that the order of the listing is based at least in part upon the ratio for each attraction in the listing, the attractions with a low ratio being listed first and attractions with a high ratio being listed last.

Thus as explained above, a wait-time ratio may be computed by the WTA, the wait-time ratio being the current wait time for an attraction divided by a typical wait time for that attraction. The typical wait time may be an average value a statistical central tendency value, or any other statistical value that is based upon previous historical wait-times for the attraction. The typical wait-time may be generated based on the time of day, day of week, or season of year. In this embodiment the wait-time ratio is:

Wait-time ratio=Current Wait Time/Typical Wait Time

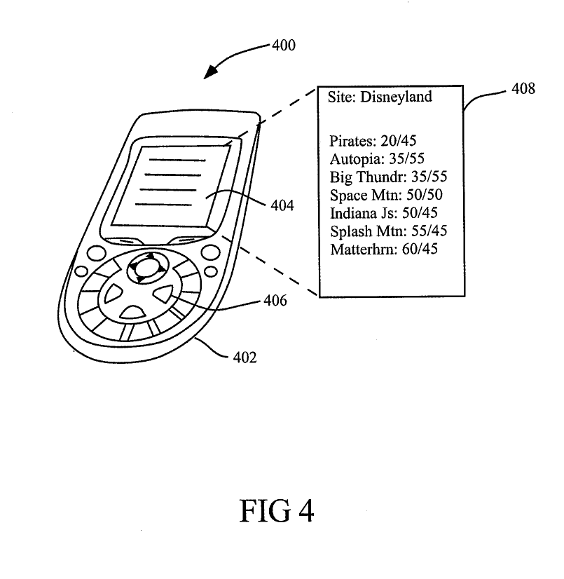

Referring next to FIG. 4, FIG. 4 shows a mobile communication device 400 according to an embodiment of the present invention. The mobile device communication device 400 includes a user interface 402 having a display 404 and a keypad 406.

The display 404 is displaying an exemplary response message 408. The response message 408 includes a listing of wait-times for attractions at the Disneyland establishment. The listing shows attractions ordered with the attractions having the most favorable wait-time ratios listed first and the least favorable wait-time ratios listed last. The ordered listing provides the customer with a convenient list of attractions ordered to provide the customer with attractions that the customer is most likely to want to visit next listed first.

The exemplary response message is formatted such that the display 404 shows “current wait time/typical wait time.” As shown, the first attraction on displayed is Pirates which is the attraction abbreviation for the Pirates of the Caribbean ride. Next to the attraction abbreviation is “20/45” that indicates the current wait-time for the ride is 20 minutes and the typical wait time for the ride is 45 minutes. A customer viewing the display 404 can quickly assess that the current wait-time for Pirates is substantially lower than the typical wait time. Thus, Pirates is a favorable choice of attraction.

In contrast, the last attraction on the list is Mattrhrn which is the attraction abbreviation for the Matterhorn Bobsleds ride. Next to the attraction abbreviation is “60/45” that indicates that the current wait-time for the ride is 60 minutes and the typical wait time for the ride is 45 minutes. Thus a customer can quickly assess that the current wait-time is substantially higher than the typical wait-time. The display format is a convenient display format for a customer since the customer can quickly assess which attractions are the most attractive from a wait-time perspective.

With respect to billing, the system described herein may be configured such that a fee is charged to customers who request wait-times for attractions. For example, the WTA may be configured to maintain a customer account database. The customer account database might be structured to reference each customer by a unique customer ID. In some embodiments, the phone number or IP address from which the customer sends a request message is the customer ID. In this way a user need not register, but may simply send an SMS message and/or other electronic message to the WTA. The WTA uses the return electronic address (i.e. phone number) as the customer ID and references the customer account stored for that mobile phone customer. The customer account database may also include a set of preferences for each user indexed with respect to the customer ID of the user. The user preferences may include user preferences for specific attractions in establishments.

In some embodiments, a customer may purchase credits or buy a subscription to the service. In other embodiments, the user is charged for each request message sent to the WTA via a reverse billing process. For example, a reverse billing SMS may be used. A receipt message may also be sent from the WTA to the mobile phone of a customer who sends a wait time request message. The customer may also be billed though their phone carrier phone without the need for the WTA to create a special account for the service.

In a preferred embodiment, the customer is billed only once per calendar day for use of the service, for example a $1.00 fee. For the rest of the calendar day, the customer may send a predetermined number of wait-time requests to the WTA without being charged again. The WTA may then send a reverse billing SMS message to the mobile phone of the customer upon receiving a first wait-time request message. The reverse billing SMS message may be a short text message receipt that says for example “Thank you for using our service; you have been charged $1.00 for unlimited requests for the rest of this calendar day.” The user is then billed $1.00 through his service provider. A record of billing is then stored and the customer may make additional wait time requests during the current calendar day at no additional cost.

For example, a customer visiting a popular establishment such as Disneyland desires wait-times. The customer sends a request message for Disneyland wait-times to the WTA. The WTA receives the message and decodes the message. The WTA accesses the WT database, retrieves wait-times for the twenty most popular attractions at Disneyland. The WTA then sends a response message to the customer that includes the accessed current wait times. In addition, to the response message the WTA sends a receipt message using a reverse billing SMS process that charges $1.00 to the phone bill of that mobile phone. The reverse billing SMS message informs the customer that they may make unlimited additional wait requests during the current calendar day. The WTA then stores a record of the requesting communication device in memory so that the WTA server does not charge the customer using the mobile phone any additional fees during that calendar day. That said, if the user sends another request message on a subsequent calendar day, the process repeats and the user is charged an additional $1.00 fee for that calendar day. Other embodiments feature other billing schemas, including for example, a weekly billing cycle or a fixed number of requests per billing cycle such as ten requests for each charge of a $1.00 fee.

Finally, although the examples described herein show only text-based displays of current wait time values, mobile phone devices that include graphical display capabilities may be configured to display a graphical map of a particular amusement park and may show the wait times for particular attractions overlaid upon the graphical map in locations that correspond with the locations of those particular attractions on the map. This will provide the user with additional information about where the attractions reside in proximity to the user as well as information about the wait times at those attractions. For embodiments that support GPS tracking, the user's location within the park establishment may also be depicted upon the graphical map. In this way the user can visually view his or her relative location to a plurality of attractions and have information displayed to the user about the substantially current wait times associated with those attractions.

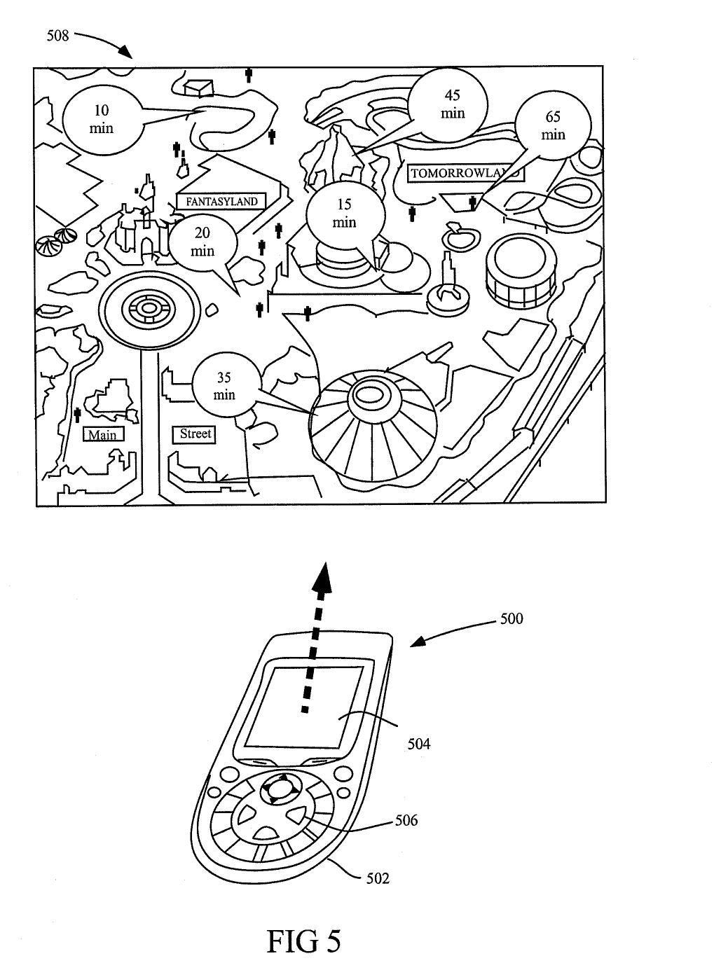

Referring next to FIG. 5, FIG. 5 shows a mobile communication device 500 according to an embodiment of the present invention. The mobile communication device 500 includes a user interface 502 having a display 504 and a keypad 506.

The display 500 shows a map view 508 of an amusement park establishment. To produce the map view 508, client software running on the mobile communication device 500 receives current-wait-times for attractions from the WTA. The client software overlays the wait-times on an establishment map. More specifically, the wait-times are displayed next to their corresponding attraction.

The map view 508 may show wait-times displayed alone as shown, or the wait-times may be displayed along with typical, average wait-times or other values of interest for the attraction.

In some embodiments, the map view 508 may also be automatically centered and displayed to the customer based on the customer's present position. The map view 508 may also include an overlay of wait-times for attractions close to the customer. This allows a customer to quickly look at the display 504 and determine the current wait-times for attractions in the vicinity and allowing the customer to make an informed decision as to which attraction the customer should visit next.

In other embodiments, the distance from the customer's present position to each attraction is also included in the map view 508. This feature is a further convenience to the customer allowing the customer to review distances to the attractions and permitting the customer to make an even more informed decision as to which attraction to visit next.

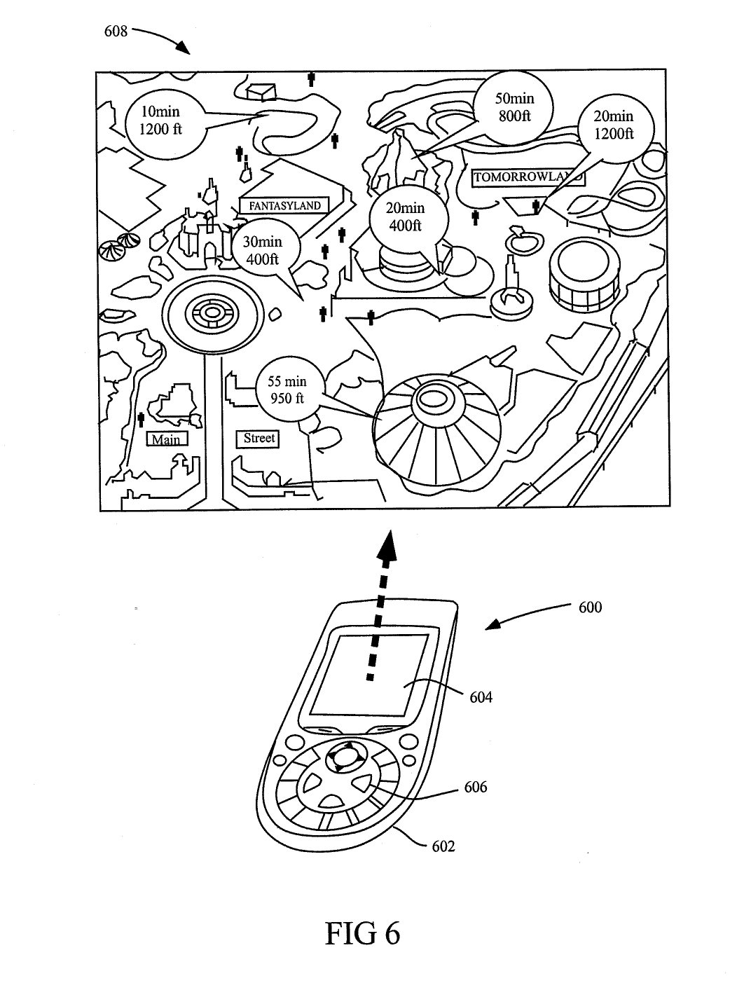

Referring next to FIG. 6, FIG. 6 shows a mobile communication device 600 according to an embodiment of the present invention. The mobile device communication device 600 includes a user interface 602 having a display 604 and a keypad 606.

The mobile communication device 600 is GPS enabled. The mobile communication device 600 has a display 604 that shows a map view 608 of an amusement park establishment with an establishment map centered on the customer's present position. Client software running in the mobile communication device 600 receives attraction wait-times from the WTA and overlays them on the establishment map.

Distances shown in the map view 608 are computed either by the client software or by the WTA from the customer's present position and the geodetic position of the attractions and the walking areas. The distances represent the approximate walking distance between the customer's present position and each displayed attraction. The customer's present position is determined by GPS and the geodetic position of the attractions and walking areas are retrieved from an attraction database.

The distance values may be line-of-sight distances or may be pathway distances that assume the most likely route of travel between the user's present position and each displayed attraction. Thus as shown in FIG. 6, each attraction of is displayed along with a current wait-time and distance value. For example the Space Mountain ride shown in the lower right corner of the display has a current wait time of 55 minutes and is 950 feet from the customer's present position. Thus the user can compare this wait-time and distance to Space Mountain with the wait-time and distance to other attractions allowing the customer to make an informed decision about which attraction to visit next.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for electronically distributing attraction wait-times to customers of a physical establishment, the method comprising:
maintaining a database of wait-times for attractions within the physical establishment, the database comprising at least one wait-time associated with each of a plurality of attractions of the physical establishment;
receiving a request message from each of a plurality of portable computing devices, each received request message requesting the wait-times for one or more attractions of the physical establishment;
retrieving for each received request message, the requested wait-times, from the database; and
sending for each received request message, a response message indicating the retrieved wait-times, the response message also indicating to which attraction each retrieved wait time relates, the response message for each received request message being sent to the portable computing device from which the request message was received.

2. The method of claim 1 wherein the request message received from each of the plurality of portable computing devices includes an establishment identifier, indicating a particular establishment from among a plurality of possible establishments.

3. The method of claim 1 wherein the database comprises wait-times for attractions within each of a plurality of separate physical establishments, each wait-time being associated with a particular attractions within a particular physical establishment.

4. The method of claim 1 wherein each received request message is an SMS text message.

5. The method of claim 1 wherein each sent response message is an SMS text message.

6. The method of claim 1 wherein the physical establishment is an amusement park and wherein the one or more attractions are rides of the amusement park.

7. The method claim 1 wherein each received request message includes an indication of a geospatial location of the portable computing device from which it was received.

8. The method of claim 1 wherein the wait times sent to each portable computing device are displayed to a user of that portable computing device upon a screen of that portable computing device.

9. The method of claim 8 wherein the wait times are displayed upon a graphical map of the physical establishment.

10. The method of claim 8 wherein the wait time for each of a plurality of attractions is displayed along with an indication of how that wait time compares with a historical or expected value.

11. The method of claim 8 wherein the wait times for each of a plurality of attractions are displayed in an order that depends at least in part upon historical or expected wait-time data.

12. The method of claim 8 wherein the wait times for each of a plurality of attractions are displayed in an order that depends at least in part upon a physical distance between the portable computing device and at least one of the plurality of attractions.

13. An apparatus for electronically distributing attraction wait-times to customers of a physical establishment, the apparatus comprising:
a database of wait-times for attractions within a physical establishment, the database comprising at least one wait-time associated each one of a plurality of attractions of the physical establishment; and
a server connected to a wireless communication link, the server adapted to,
receive a request message from each of a plurality of portable computing devices, each received request message requesting the wait-times for one or more attractions of the physical establishment;
retrieve for each received request message, the requested wait-times, from the database; and
send for each received request message, a response message indicating the retrieved wait times and the attractions to which the wait time relate, the response message for each received request message being sent to the portable computing device from which the request message was received.

14. The apparatus of claim 13 wherein the request message received from each of a plurality of portable computing devices includes an establishment identifier, indicating a particular establishment from among a plurality of possible establishments.

15. The apparatus of claim 13 wherein the database comprises wait-times for attractions within each of a plurality of separate physical establishments, each wait-time being associated with a particular attractions within a particular physical establishment.

16. The apparatus of claim 13 wherein each received request message is an SMS text message.

17. The apparatus of claim 13 wherein the physical establishment is an amusement park and wherein the one or more attractions are rides of the amusement park.

18. The apparatus claim 13 wherein each received request message includes an indication of a geospatial location of the portable computing device from which it was received.

19. The apparatus of claim 13 wherein the wait times sent to each portable computing device are displayed to a user of that portable computing device upon a screen of that portable computing device.

20. The apparatus of claim 13 wherein the wait time for each of a plurality of attractions is displayed along with at least one of an indication of how that wait time compares with a historical value, an indication of how that wait time compares with an expected value, and an indication of how far away the attraction is from the current location of the portable computing device.
